(19) United States
(12) Patent Application Publication
(10) Pub. No.: US 2015/0356500 A1
(43) Pub. Date: Dec. 10, 2015

(54) Systems, Methods, and Devices for Monitoring Blood Products During Portable Storage and Transport

(71) Applicant: The Board of Trustees of the Leland Stanford Junior University, Stanford, CA (US)

(72) Inventors: Barrett J. Larson, Palo Alto, CA (US); Benjamin Lubkin, Rye Brook, NY (US)

(73) Assignee: The Board of Trustees of the Leland Stanford Junior University

(21) Appl. No.: 14/736,108

(22) Filed: Jun. 10, 2015

Related U.S. Application Data
(60) Provisional application No. 62/010,445, filed on Jun. 10, 2014.

(51) Int. Cl. G06Q 10/08; G06K 7/10

(52) U.S. Cl. CPC G06Q 10/0832; G06K 7/10366; G06Q 50/22

(57) ABSTRACT

Systems and methods for monitoring blood products using portable storage units (“PSUs”) are disclosed. A PSU can be configured to communicate with a blood product management server for monitoring blood products. In many embodiments, a PSU can include a cooling mechanism to control the internal temperature of the PSU, a RFID reader configured to scan at least one RFID tag associated with at least one blood product, a processor, and a memory containing a PSU application, wherein the PSU application configures the processor to: determine a temperature profile for the at least one blood product, generate health status information for the at least one blood product based upon the blood product's temperature profile, generate a user interface that includes information regarding the at least one blood product's health status information, and transmit the at least one blood product's health status information to the blood product management server.

### CROSS-REFERENCE TO RELATED APPLICATIONS

The current application claims priority to Provisional Patent Application No. 62/010,445 filed Jun. 10, 2014, titled Systems, Methods, and Devices for Monitoring Blood Products during Portable Storage and Transport, the disclosure of which is incorporated herein by reference.

### STATEMENT OF FEDERALLY SPONSORED RESEARCH

This invention was made with Government support under contract TR001085 awarded by the National Institutes of Health. The Government has certain rights in the invention.

### FIELD OF THE INVENTION

The present invention generally relates to blood transfusions and more specifically to systems and methods for monitoring blood products during storage and transport.

### BACKGROUND

Blood products can be collected from donors and stored in a blood bank for later use in blood transfusions (i.e. the process of receiving blood products into one's circulation intravenously). Whole blood can be separated into components such as (but not limited to) red blood cells, plasma, clotting factors, and platelets. Typically, transfusions are utilized to replace lost components of blood for a variety of medical conditions. The term blood product can be used to identify one or more blood components. Although not necessarily the case, a blood bank is often a division within a hospital.

### SUMMARY OF THE INVENTION

Systems and methods for monitoring blood products using portable storage units (“PSUs”) in accordance with embodiments of the invention are disclosed. In one embodiment, a PSU configured to communicate with a blood product management server for monitoring blood products includes a cooling mechanism to control the internal temperature of the PSU, a RFID reader configured to scan at least one RFID tag associated with at least one blood product, a processor, and a memory containing a PSU application, wherein the PSU application configures the processor to: determine a temperature profile for the at least one blood product, generate health status information for the at least one blood product based upon the blood product's temperature profile, generate a user interface that includes information regarding the at least one blood product's health status information, and transmit the at least one blood product's health status information to the blood product management server.

In a further embodiment, the health status information is the temperature profile.

In another embodiment, the PSU also includes at least one temperature sensor to measure the internal temperature of the PSU.

In a still further embodiment, the internal temperature of the PSU is maintained between 1 and 6 degrees Celsius.

In still another embodiment, the PSU application also configures the processor to determine the temperature profile for the at least one blood product based upon the measured internal temperature of the PSU.

In a yet further embodiment, the PSU application also configures the processor to determine the temperature profile for the at least one blood product based upon the at least one blood product's specific heat, bag characteristics, and ambient temperatures.

In yet another embodiment, the PSU application also configures the processor to store a PSU entry time for the at least one blood product.

In a further embodiment again, the PSU application also configures the processor to store a PSU exit time for the at least one blood product.

In another embodiment again, the PSU is also configured to communicate with a control station that includes at least one RFID reader configured to scan blood products for check-in and check-out.

In a further additional embodiment, the PSU application also configures the processor to determine the at least one blood product's temperature profile based upon an elapsed time between the at least one blood product's check-out time and PSU entry time.

In another additional embodiment, the blood product management server includes a processor and a memory containing a blood product management server application, where the blood product management server application configures the processor to: receive the check-in and check-out times for the at least one blood product from the control station, receive the PSU entry and exit times for the at least one blood product from the PSU, and generate at least one alert based upon a difference in the at least one blood product's check-out and check-in times plus the difference in the PSU entry and exit times.

In a still yet further embodiment, the blood product management server application also configures the processor to generate at least one alert based upon the at least one blood product's health status information and pre-determined thresholds.

In still yet another embodiment includes monitoring blood products using a PSU configured to communicate with a blood product management server, by controlling the internal temperature of the PSU using the PSU, wherein the PSU comprises a cooling mechanism, scanning at least one RFID tag associated with at least one blood product using the PSU, wherein the PSU comprises a RFID reader, determining a temperature profile for the at least one blood product using the PSU, generating health status information for the at least one blood product based upon the blood product's temperature profile using the PSU, generating a user interface that includes information regarding the at least one blood product's health status information, and transmitting the at least one blood product's health status information to the blood product management server using the PSU.

In a still further embodiment again includes monitoring blood products where the health status information is the temperature profile.

In still another embodiment again includes monitoring blood products where the PSU also includes at least one temperature sensor to measure the internal temperature of the PSU.

In a still further additional embodiment includes monitoring blood products where the internal temperature of the PSU is maintained between 1 and 6 degrees Celsius.

In still another additional embodiment includes monitoring blood products also by determining the temperature profile for the at least one blood product using the PSU based upon the measured internal temperature of the PSU.

In a yet further embodiment again includes monitoring blood products also by determining the temperature profile for the at least one blood product using the PSU based upon the at least one blood product's specific heat, bag characteristics, and ambient temperatures.

In yet another embodiment again includes monitoring blood products also by storing a PSU entry time for the at least one blood product using the PSU.

In a yet further additional embodiment includes monitoring blood products also by storing a PSU exit time for the at least one blood product using the PSU.

In yet another additional embodiment includes monitoring blood products also by communicating with a control station comprising at least one RFID reader configured to scan blood products for check-in and check-out.

In a further additional embodiment again includes monitoring blood products also by determining the at least one blood product's temperature profile using the PSU based upon an elapsed time between the at least one blood product's check-out time and PSU entry time.

In another additional embodiment again includes monitoring blood products also by receiving the check-in and check-out times for the at least one blood product from the control station using the blood product management server, receiving the PSU entry and exit times for the at least one blood product from the PSU using the blood product management server, and generating at least one alert based upon a difference in the at least one blood product's check-out and check-in times plus the difference in the PSU entry and exit times using the blood product management server.

In a still yet further embodiment again includes monitoring blood products also by generating at least one alert based upon the at least one blood product's health status information and pre-determined thresholds using the blood management server.

### BRIEF DESCRIPTION OF THE DRAWINGS

FIG. 1 is a system diagram of a blood product monitoring system in accordance with an embodiment of the invention.

FIG. 2 illustrates a blood product management server in accordance with an embodiment of the invention.

FIG. 3 illustrates a portable storage unit in accordance with an embodiment of the invention.

FIG. 4 is a flow chart illustrating a process for monitoring blood products in accordance with an embodiment of the invention.

FIGS. 5A-C are flow charts illustrating processes for triggering alerts in monitoring blood products in accordance with an embodiment of the invention.

FIGS. 6A-D are flow charts illustrating room-temperature exposure time tracking in accordance with an embodiment of the invention.

FIGS. 7A-D are flow charts illustrating temperature tracking in accordance with an embodiment of the invention.

### DETAILED DESCRIPTION OF THE DRAWINGS

Turning now to the drawings, disclosed are systems and methods for monitoring blood products using portable storage units (“PSUs”) that are in accordance with embodiments of the invention. In many embodiments, blood product monitoring systems can include an active or passive radio-frequency identification (“RFID”) tag that is associated with each blood product. In several embodiments, a PSU is stationed at the point-of-care and configured to continuously monitor blood products utilizing an integrated RFID reader and RFID antennas and a variety of other sensors, as further described below. In various embodiments, the PSU can communicate wirelessly to a blood product management server to provide information about the PSU, blood product entry and exit times, and real-time updates regarding a blood product's health status, location, and other information. The term “health status”, as used herein, can represent any condition associated with the blood product, such as the entire temperature history, room-temperature exposure profile, life-span, and any other storage or environmental conditions that can impact the viability of a blood product or influence the probability of bacterial contamination. In many embodiments, a blood product's health status can include conditions such as (but not limited to) a blood product's room-temperature exposure profile and the blood product's temperature profile. It should be noted that the term “profile” can refer to any historical information regarding the temperature conditions or room-temperature exposure periods for a given blood product. In some implementations, “room-temperature” can refer to the ambient environmental temperature within a monitoring environment. In many embodiments, the system can allow for a user to define parameters and/or thresholds in monitoring the blood product during transport and storage. These parameters can include temperature and time. In a variety of embodiments, any product in jeopardy of violating such pre-determined thresholds can be identified and appropriate alerts can be triggered. Further, when an unused blood product is returned, it can be scanned using its RFID tag and the system can determine if the blood product is suitable for future transfusion. Although specific terms such as (but not limited to) check-in station, check-out station, and PSU, are utilized throughout this application, the specific terms are modifiable and used only for illustrative purposes. Thus, other specific terms could readily be used in their place or in addition to the specific terms utilized. Blood product monitoring systems in accordance with embodiments of the invention are further discussed below.

### Blood Product Monitoring Systems

The blood product “cold chain” refers to a process for ensuring that blood products remain at desired temperature or storage conditions from the time of donor collection until patient transfusion. Typically, the process includes a series of interconnected activities involving both personnel and equipment, where breaks in the cold chain can lead to unnecessary wastage of blood products (blood products that have violated temperature or storage parameters generally need to be discarded). In clinical practice, the weakest link in the cold chain often occurs in the operating room. Due to the high-acuity nature of the operating room environment, proper storage of blood products does not always take top priority. Not promptly placing blood products in a suitable storage system may result in the blood product's temperature or storage parameters falling outside of desired (or required) ranges.

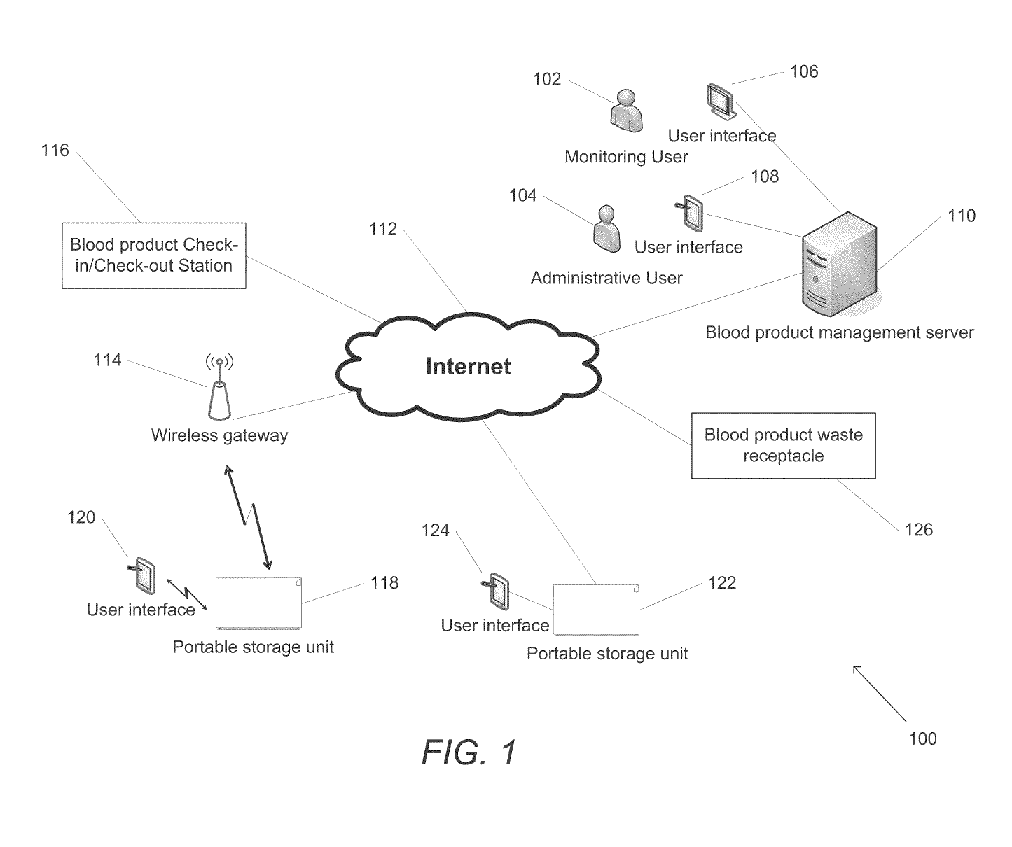

A blood product monitoring system in accordance with an embodiment of the invention is illustrated in FIG. 1. The system 100 includes a blood product management server 110 in network communication with a blood product check-in/check-out station 116, a blood product waste receptacle 126, and at least one portable storage unit (“PSU”) 118, 122 for monitoring blood products as further described below. In many embodiments, various users including (but not limited to) a monitoring user 102 and/or an administrative user 104 can access the blood product management server via graphical user-interfaces 106, 108 respectively. Typically, blood products are individually associated with an RFID tag as further described below. In several embodiments, the blood product check-in/check-out station 116 can include at least one RFID reader (and antenna) for scanning an RFID tag associated with a blood product. Further, the RFID scanning process can also be associated with temperature measuring, such that the temperature of the blood product can be measured upon leaving and returning to a blood bank as further described below. In some implementations, a temperature sensor is incorporated into the RFID tag or associated with the RFID tag, such that the temperature of the blood product is reported upon scanning of the RFID tag. When a blood product is requested, it can be checked-out and transported to PSUs 118, 122 for remote storage at a blood transfusion location. In some embodiments, immediately upon checkout, the blood products are put into a PSU, which is then used to transport blood products to the desired location. In many embodiments, the PSUs can be configured to communicate with other components of the system 100 via a wired or wireless connection including via Wi-Fi or using a cellular data network 114 (i.e. wireless gateway) to connect to the Internet 112. In various embodiments, portable storage units 118, 122 can also include graphical user interfaces 120, 124 for presenting and receiving information from additional users.

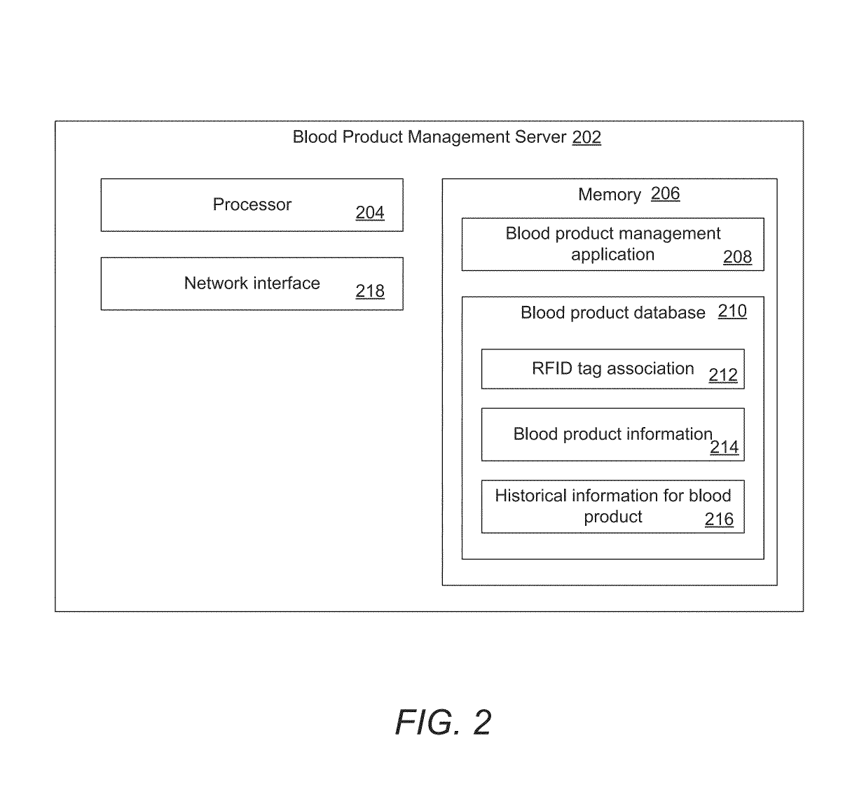

As discussed above, a blood product monitoring system can include a blood product management server for monitoring blood products. A blood product management server in accordance with an embodiment of the invention is illustrated in FIG. 2. The blood product management server 202 includes a processor 204 and a memory 206 that includes a blood product management application 208. The blood product management application 208 is utilized to configure the processor to perform various functions including (but not limited to) monitoring and triggering system alerts, tracking room temperature exposure profile, tracking temperature profiles, and tracking the health status of blood products as further discussed below. In several embodiments, the memory 206 includes a blood product database 210 that can store information used in monitoring blood products including (but not limited to) RFID tag associations 212, blood product information 214, and historical information for a blood product 216. In various embodiments, the blood product management server 202 includes a network interface 218 to communicate with various components of the monitoring system via the Internet. In the illustrated embodiment, the memory 206 is a machine readable media that is utilized to store machine readable instructions that configure the processor 204. In many embodiments, the server 202 can also track the real-time location of the PSU and other components of the system.

### Graphical User Interfaces

In many embodiments, the blood product management application can configure the processor to receive and present information using a user-interface. In several embodiments, the user-interface can include a main screen where users can select from various options including (but not limited to): 1) Check-Out Blood Products, 2) Check-In Blood Products, and 3) Monitor Blood Products. The “Check-Out Blood Products” option can lead to a submenu where users may select the desired final location of the blood products to be transported. The final location can be designated as a room number, department, person, patient, or any other identifier. In various embodiments, the destination location can be selected from a drop down menu. Further, a patient's name or other identifiable characteristics can be selected. In some implementations, the association between a particular blood product and a patient or location is provided from a separate database and therefore does not need to be manually selected at the time of checkout. When the blood products are ready to be transported, a user can scan one or more blood products using the RFID antenna where an audible and/or visual notification can indicate that the blood product(s) were successfully checked-out. The blood product(s) can be subsequently registered as “checked-out” and monitored as further described below. In addition, the RFID tags associated with the blood products can have specified colors, markings, shapes, electronic encoding, color-coded graphics and a unique ID number in memory, or other indicators that indicate the type of blood product being monitored, and therefore the type and number of issued blood products can be recorded.

In a variety of embodiments, the main screen can also include a “Check-In Blood Products” option leading to a submenu where users can check-in blood products and view historical information regarding each blood product. Typically, the blood product can be scanned over an RFID antenna. In several embodiments, an audible and/or visual notification can indicate that the blood product was successfully checked-in. In addition, the time-temperature (or room exposure) profile of the specific blood product can be displayed on the user interface. Further, users can define pre-determined thresholds for the time and temperature parameters to govern which products are suitable for future donation as further described below. If a particular blood product falls outside of the predetermined thresholds, an indication of this fault can be provided. Furthermore, a visual indicator such as (but not limited to) a green or red indicator with associated text can indicate to blood bank personnel if a particular unit is suitable for future transfusion.

In many embodiments, the main screen can also include a “Monitoring Blood Products” option leading to a submenu where users can monitor the status of all blood products that have left the blood bank and the user can monitor the status of each active PSU in the system. Alerts and notifications can be provided to indicate faults in the system as further described below. If a request to return blood products has been entered at the point-of-care, this notification can appear on the user interface. If a particular PSU is outside of predetermined temperature ranges, the user can monitor and act on this information. If a blood product is inadvertently delivered to the wrong location and placed in the wrong PSU, the blood bank and other personnel can immediately be notified. Other alerts and notifications can include various status reports of system components, such as (but not limited to) technical faults with the RFID or wireless communication systems, low battery, PSU lid closure faults, to name a few. In some embodiments, in an emergency situation where the blood bank may have run out of a specific product, the system can identify the location of appropriate units elsewhere in the hospital.

### Defining Pre-determined Thresholds

In addition to monitoring blood products, users with appropriate privileges can pre-determine various thresholds that determine whether or not blood products should be wasted. For example, specific thresholds for time-temperature can be defined, and blood products that fall outside of pre-defined thresholds can be flagged as “not suitable for future donation”. In many embodiments, time-temperature profiles can include thresholds such as (but not limited to) maximum acceptable room-temperature exposure times, maximum acceptable cumulative room-temperature exposure times, maximum acceptable transport exposure time, maximum/minimum acceptable transport temperatures, maximum time over a given temperature, maximum/minimum acceptable temperatures, and maximum/minimum acceptable PSU temperatures to name a few.

Also, through the user interface, blood bank personnel have the ability to monitor the wastage rate and also correlate wastage with particular locations or providers. In such a fashion, the system facilitates root cause analysis to improve the handling of blood products. In several embodiments, the user-interface can be accessed from any web-enabled device, such that monitoring can be done remotely.

In addition, the blood product management server can contain information regarding the expiration date of all blood products in the blood bank. If an attempt is made to ‘check-out’ an expired product, users can be alerted. Given the knowledge of expiration dates, blood products that are set to expire can be prioritized for transfusion. Furthermore, the system described herein could aggregate all enterprise data into report documentation that can be reviewed by blood bank personnel and administrators.

Although specific systems for monitoring blood products are discussed above with respect to FIGS. 1-2, any of a variety of systems including a variety of system components, user interfaces, and pre-determined thresholds as appropriate to the requirements of a specific application can be utilized in accordance with embodiments of the invention. PSUs in accordance with embodiments of the invention are discussed further below.

### Portable Storage Units

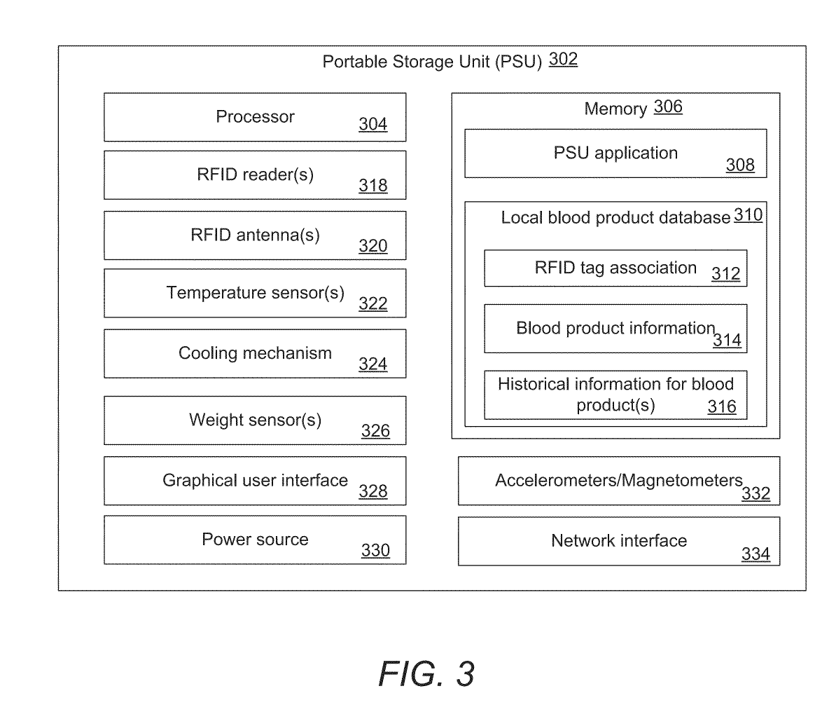

A portable storage unit (“PSU”) is typically stationed at the point-of-care location, but is portable by nature and can also be used to transport blood products. A PSU in accordance with an embodiment of the invention is illustrated in FIG. 3. The PSU 302 includes a memory 306 that contains a PSU application 308 that configures the processor 304 to monitor blood products and provide updates and alerts to a blood product management server as further discussed below. In many embodiments, the memory 306 includes a local blood product database 310 that stores information including (but not limited to) RFID tag associations 312, blood product information 314 and historical information for blood products 316. In a variety of embodiments, the PSU 302 includes a network interface 334 to connect to the Internet and communicate with the blood product management server. Although a specific network interface is illustrated, a PSU can contain various wired or wireless communication means so that data can be communicated to and from a blood product management server and ultimately relayed to blood bank personnel. In many embodiments, the wireless communications protocol can include (but is not limited to) Wi-Fi, Bluetooth, cellular, or any other suitable communications protocol.

In several embodiments, the PSU 302 can include a cooling mechanism 324 to maintain a predetermined temperature within the PSU. The cooling mechanism can include ice, phase-change material, thermoelectric cooling, or any other suitable cooling means. Further, PSUs in accordance with embodiments of the invention may have insulating features to optimize the container's thermal properties such as (but not limited to) the internal structure of the PSU comprising a phase-change material to help maintain a desired temperature of the blood products. In various embodiments, the PSU can be designed to maintain an internal temperature at a specified range, such as (but not limited to) between 1-6° C. Further, the cooling mechanism 324 can include a cooling element (such as ice packs, cooling packs, or thermoelectric cooling). In such embodiments, the cooling element can be easily removed or exchanged. Typically, the blood products do not come into direct contact with the cooling element. In various embodiments, the cooling element may be re-usable or “rechargeable”. In the case of thermoelectric cooling, rechargeable batteries can be provided or the device can be connected to wall power. Also, the cooling element may have a unique RFID tag such that the system can monitor the presence, absence, length of use of the cooling element, and other parameters using the RFID reader. In many embodiments, an individual cooling element can have a maximum continuous usage time. Thus, users can be notified via the user-interface if a particular cooling element should be exchanged or replaced. In several embodiments, the cooling mechanism can be provided by an electrical refrigeration means, such as (but not limited to) a thermoelectric cooling element. In many embodiments, the PSU 302 includes at least one temperature sensor 322 that can be configured to provide a feedback loop to ensure optimal storage temperature conditions.

In addition to cooling, the PSU 302 can have an internal structure that supports a plurality of blood products. The support structure can be designed in such a fashion that blood products are compartmentalized. Each compartment can be designed to accommodate one or more blood products. The compartments may also be associated with one or more temperature sensors 322. In many embodiments, each compartment can accommodate one blood product, where each blood product can easily slide in and out of a compartment. In various embodiments, the compartment resembles a flexible sleeve that can change its conformation in order to embrace the blood product. In several embodiments, the compartment does not have a bottom or top, but rather the compartment has a funnel shape that supports the product and prevents it from falling through. In a variety of embodiments, the individual compartments (or sleeves) can function as heat sinks, such that the optimal temperature of the blood products can be maintained. In many embodiments, it may be desirable to limit the number of potential orientations that the blood products can assume within the compartment. This can be accomplished by attaching the blood bags to the support structure using hooks. In several embodiments, the PSU 302 can include at least one weight sensor 326 for determining the weight of a blood product and/or for verification of RFID read accuracy. In some embodiments, the internal compartment is designed such that when blood products are put into the PSU, there is a limit to how closely the blood products can directly touch each other.

In various embodiments, the PSU includes at least one RFID reader 318 and at least one RFID antenna 320 for scanning blood products received from the blood bank. In some implementations, the blood products are tagged with an RFID tag that is placed on the top or bottom edge of the blood product bag. In such a fashion, when the tagged blood product is placed into a compartment within the PSU, the tag may be substantially extending out of the compartment. This arrangement may help improve communication between the RFID tag and the RFID reader. Further, in some implementations, the plurality of individual compartments can be arranged in a staggered or offset fashion, such that RFID tags from blood products are not overlapping and RFID communication can be optimized. In some implementations, the tags are placed anywhere on the blood product and the RFID reader is capable of reading through any internal compartments or other substance intervening between RFID tag and the antenna.

In some embodiments, the PSU has no internal compartmentalization, and blood products are randomly distributed and arranged within the PSU. Although sensing of individual RFID tags can be more difficult, such a configuration could be enabled by providing more robust RFID sensing, including through the use of multiple antennas. Although RFID configurations for monitoring blood products are discussed throughout this application, RFID is one of many possible wireless communication protocols that could be used. Other protocols can include (but are not limited to) Bluetooth Low Energy, Bluetooth, Zigbee, NFC, or other lower-frequency technologies that have improved communication through solids and liquids and gasses.

In many embodiments, the internal support structure is removable, such that a plurality of blood products can be quickly removed from the containment unit. This allows quick exchange of cooling elements. Furthermore, the PSU needs to be amenable to cleaning with disinfectant solutions. To achieve that goal, all electronic components need to be substantially resistant to a standard disinfectant process.

In several embodiments, the PSU 302 may contain a power source 330 such as (but not limited to) a battery to provide power for the embedded electronics (RFID reader, microcontrollers, sensors, visual display, etc.). The battery can be embedded in the walls or base or other area of the PSU. Typically, the battery is thermally isolated from the internal storage compartment and can be associated with a heat sink that dissipates heat to the external environment. In some embodiments, the battery is able to support continuous use of the device for extended periods and may be rechargeable, either by wireless or wired means. The PSU may also include a power cord that can retract or be wrapped, or fastened to the PSU. The PSU may also have a charging outlet, whereby an external power cord can be inserted to provide charging. In some embodiments, a visual display can indicate the status of the battery. When the device is not being used, a visual display on the side of the device can indicate the battery life. This display may incorporate RGB LED lighting or additional long-range visual indication techniques. In such a fashion, users can choose to use a PSU that is sufficiently charged. In some implementations, the PSU's battery can be quickly swapped out and replaced with a charged battery. When the PSU is in use, the battery status may also be provided via a separate visual display, such as a tablet computer embedded in the lid of the device. Further, the PSU has a power switch whereby users can turn the PSU on or off.

In addition, the PSU contains sensors that can be used to indicate if the lid of the storage unit is opened or closed. The sensors can include (but are not limited to) contact sensors, proximity sensors, accelerometers 332, or magnetometers 332 that are associated with the PSU, or any other sensing means that can indicate proper closure of the PSU's lid. Also, the PSU can have handles or straps to facilitate transport and wheels such that it can be rolled. Given that this is a portable storage unit, the weight of the device should not be excessive.

### Temperature Sensing

As mentioned, the blood products may be contained within individual compartments. In many embodiments, each compartment may be associated with one or more temperature sensors 322, such that the temperature of each individual blood product can be monitored. In other embodiments, the temperature sensors 322 are not associated with specific compartments, but rather the internal temperature of the PSU is monitored and recorded. Further, the temperature of the cooling element can be measured. For example, a thermocouple in the base of the PSU (oriented internally) can be used to measure the temperature of a cooling element that is placed in the bottom of the PSU. The temperature of the cooling element can be used to approximate the internal temperature of the PSU (based on the known thermodynamic properties of the PSU and its contents, the internal temperature can be estimated in a manner familiar to one of ordinary skill in the art). In some implementations, one or more thermal sensors measure the internal temperature of the storage unit, and these values may be averaged.

In various embodiments, the temperature of specific blood products may not be individually monitored. However, the time frame(s) that each blood product spent in the PSU (and the temperature profile of the PSU over these time frames) can be used to estimate the temperature profile of each individual blood product. For example, if a blood product leaves the blood bank at a known temperature, and then spends 59 minutes out of a total of 60 minutes (98% of time) inside the PSU (temperature measured by an internally mounted thermocouple) and 1 minute was spent outside the storage unit (room temperature as defined by a system administrator or measured by an ambient thermocouple), the time-temperature profile of the blood product can be accurately determined based on the known thermodynamic and heat-transfer properties of the blood product in a manner well known to one of ordinary skill in the art.

In many embodiments, the time-temperature profile of an individual blood product can be further improved by accounting for the opening and closing of the PSU's lid. The longer the lid is open, the more the internal temperature of the PSU will equilibrate with the external environment. Models can be generated to determine exactly how lid opening affects the internal temperature of the PSU, and these models can be applied to processes that estimate the time-temperature profile of individual blood products as discussed in this application.

In several embodiments, the PSU can include a temperature sensor that is used to monitor the temperature of the external environment. Given that the system of the present invention can determine if a specific blood product is contained inside or outside of the PSU, the environmental temperature can be useful to predict blood temperature during the time outside of the PSU. With this information, and the known thermodynamic and heat-transfer properties of the blood products, the temperature profile of each individual blood product can be estimated.

Given the temperature sensing means described herein, the blood bank can be provided with an exact or estimated temperature profile for each blood product during its time away from the blood bank. In such a fashion, blood bank personnel can use this information to determine the suitability of the blood product for future donation. For example, if it is determined that the blood product reached a maximum temperature of 20° C., that product may be considered compromised, regardless of its final temperature upon return to the blood bank.

The temperature sensing means described herein are typically more tolerant of transient changes in environmental conditions. Another common way of tracking the temperature of blood products during transport and portable storage involves using a non-reversible temperature sensitive indicator. This indicator is adhered to the blood product and the indicator's color will change if its temperature ever rises above a specified temperature, such as 10° C. Since the color change is non-reversible, the tag is designed to indicate if an unsafe temperature condition ever existed. However, a drawback of this temperature monitoring method is that typical handling of the blood products can inadvertently trigger a color change. If a warm finger or hand comes into contact with the temperature indicator, it can inadvertently cause a color change, which may result in improper wastage of the blood product. The systems and methods described herein can provide a more reliable means for monitoring the temperature profile of individual blood products and does so in a fashion that minimizes inappropriate wastage (i.e. indicating that a temperature fault occurred when one did not).

### RFID Sensing

As mentioned, in many embodiments the system can include at least one RFID sensor. The system may have one or more RFID antennas 320 and readers 318. In various embodiments, the system has a single RFID reader 318 that is associated with one or more RFID antennas 320. In several embodiments, the antennas can be arranged in a fashion such that it can communicate with RFID tags that are associated with individual blood products. In a variety of embodiments, the RFID tags are passive, but they also may be active in some implementations. Further, the RFID tags should be able to communicate on or through fluids and various types of solids (i.e. plastic). In some embodiments, the RFID tags can be arranged in a fashion such that there is minimal interaction with fluid, as described above. In addition, the RFID tags can have different colors based on whether they are designated for blood, plasma, platelets, other products, or other elements of the system (i.e. the exchangeable cooling element, etc.).

Typically, the RFID reader is used to detect the presence or absence of a specified blood product, and communicates this information to a blood product management server. At the same time, the temperature condition of the PSU and the temperature of the external environment can also be communicated to the server. In such a fashion, the PSU is able to continuously track the time-temperature profile for each individual blood product. Furthermore, this data may be wirelessly communicated in real-time to the blood bank, such that the location and temperature of each stored unit can be closely monitored. When blood products are ultimately returned to the blood bank, a report for each product can be generated, which can include (but not limited to): 1) the length of time the blood product remained inside the PSU, 2) the temperature profile of the PSU, 3) the length of time the blood product was out of the PSU, 4) the exact or estimated time-temperature profile of each blood product, and 5) the health of the blood based on pervious usage. With this information, decisions can be made regarding the suitability of the product for future donation.

### Graphical User-Interface

In many embodiments, the PSU may contain a graphical user interface 328. In various embodiments, the user-interface 328 may be displayed on a tablet computer or LCD screen that is embedded into the lid of the PSU where the user-interface provides a means for data display and entry.

Further, the user-interface on the PSU may provide users with a means for designating their location (i.e. operating room #4). The location may be selectable from a pre-populated drop-down list. In addition, the location of the PSU may be automatically determined via triangulation within an RF or wireless communication environment. If the location cannot be determined precisely, users may be provided with one or more possible locations that they can select from.

In several embodiments, a user can enter the name and/or medical record number and/or other identifying information for the patient that will be receiving the blood products contained within the PSU. Associating the PSU with a specific location and/or patient helps provide a safeguard against the administration of incompatible blood products. The transfusion of incompatible blood is generally related to human error and reflects a failure to comply with standard policies and procedures. Given that the system's RFID reader can read a specific blood product, and that each blood product is assigned to a specific patient and/or location, if an incompatible blood product is inadvertently placed into the PSU, a notification can be provided to alert users of the error. To further strengthen the safeguards against the administration of incompatible blood, the patient can be associated with an active or passive RFID tag that is capable of communicating with the PSU or directly to the RFID tag associated with a blood product. In such a fashion, a link is established between the patient, the PSU, and the blood products. If incompatible blood products are brought in proximity to the patient (or placed in the PSU), an alert notification can be provided.

The user-interface can provide information to users, which may include all or part of the following data:

1) The exact or estimated time-temperature profile of each blood product that has been issued by the blood bank for the patient;

2) The internal temperature profile of the PSU;

3) The current temperature of the PSU;

4) The anticipated time remaining before the cooling element needs to be replaced or recharged;

5) The total number and type of blood products that have been issued;

6) The total number and type of blood products that have been issued and are currently contained within in the PSU;

7) The total number and type of blood products that have been transfused;

8) The battery life of the PSU;

9) The defined location of the PSU (may be modifiable);

10) The name of the patient or other identifying information;

11) The blood type of the patient;

12) The blood products that should be “used first” can be indicated via the user interface (in some situations, based on the blood product's expiration date, the blood products health status, or the status of the blood bank inventory, certain issued blood products may have a “use first” designation);

13) The number and type of available blood products on hold in the blood bank can be displayed;

14) The status of blood products en route to the specified location; and

15) The status of the wireless and/or RFID communication.

The user-interface can provider alerts to providers, which may include (but not limited to):

1) An improper blood unit has been placed in the PSU. This may include an incompatible blood product designated for a different patient, or a type of blood product that should not be refrigerated (i.e. platelets);

2) An improper combination of blood products has been placed in the PSU (for example, the PSU may be certified to hold limited combinations of blood product);

3) Any problems with the wireless signal, RFID sensing, temperature sensing, battery, or other system components;

4) The cooling element needs to be replaced; and

5) The lid has been open for longer than an administrator defined time length.

The user-interface may also allow providers to enter information into the system, such as (but not limited to):

1) Request to return blood products; (this function may be used to notify blood bank personnel or others that the blood products will be returned to the blood bank. In some implementations, all or some of the issued and unused blood products can be designated for return);

2) The location of the PSU can be entered;

3) The patient's name or other identifying information can be entered;

4) Access a wireless network (may be limited to user with administrative privileges).

Although specific PSUs for monitoring blood products are discussed above with respect to FIG. 3, any of a variety of PSUs including a variety of sensors, RFID configurations, and user interfaces, as appropriate to the requirements of a specific application can be utilized in accordance with embodiments of the invention. Processes for monitoring blood products using RFID tags in accordance with embodiments of the invention are discussed further below.

### Blood Product Monitoring Using RFID

An RFID tag can be placed on each blood product and thus a unique RFID tag can be linked to each unique blood product. Users can associate the RFID tag with a specific blood product by scanning or manually entering identifying information for each blood product and linking it to the RFID tag.

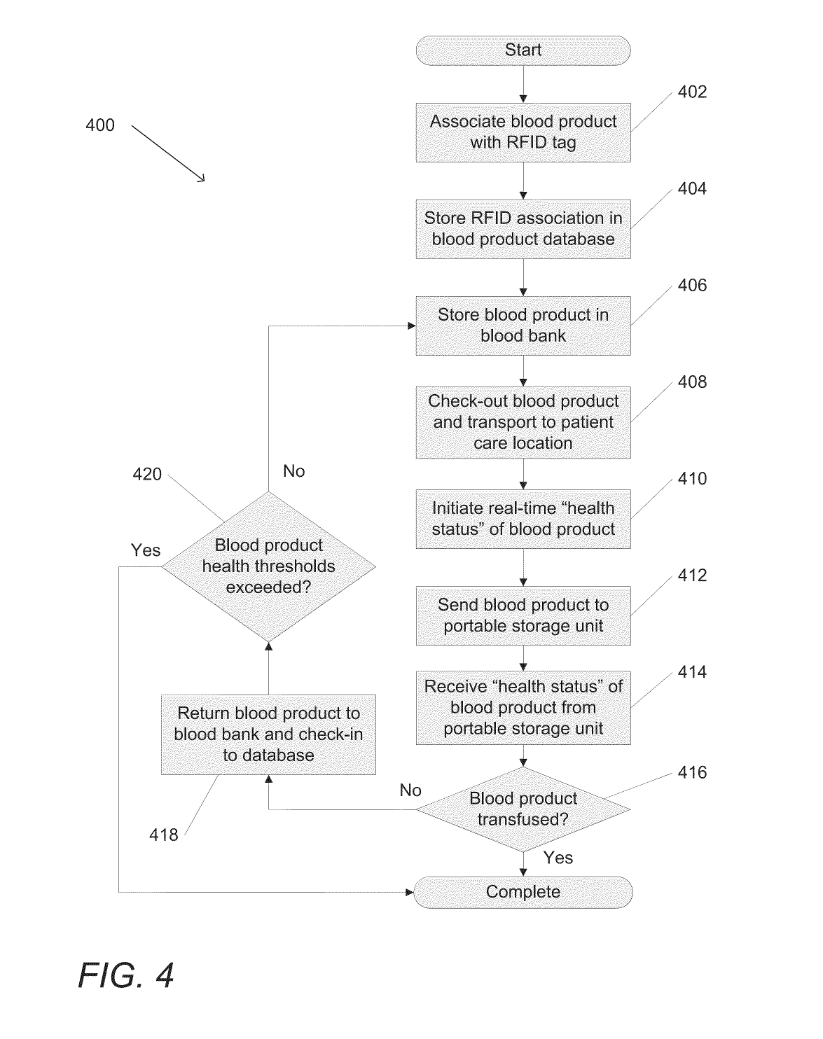

A process for monitoring blood products using RFID tags in accordance with an embodiment of the invention is illustrated in FIG. 4. The process 400 includes physically associating (402) a blood product with an RFID tag. Typically, the blood product is drawn from a donor and placed inside a container such as (but not limited) to a bag made of plastic. In many embodiments, the RFID tag can be placed onto the bag or pre-incorporated into the bag directly. The blood product can also include a unique blood product identifier such as (but not limited to) a printed number that allows for association with a unique RFID tag. The process 400 also includes electronically storing (404) the RFID association in a blood product database of a blood product management server as described above. In many embodiments, the blood product is checked-in when the RFID association is stored. Typically, a check-in/check-out station is physically located at a blood bank where the blood product can be properly stored (406). Once a request for a blood product is received, the blood product is checked-out (408) using the check-in/check-out station. In various embodiments, the process further includes initiating (410) real-time health status of the blood product as it sets out (412) for transport to a PSU at the requested location. A PSU can receive and further monitor the blood product as further discussed below. In several embodiments, the blood product management server receives (414) the health status of the blood product from the PSU. If the blood product is transfused (416) the process is complete. If the blood product is not utilized for transfusion (416) then it is returned (418) to the blood bank and checked-in prior to determining whether to store the blood product for future use. If the blood product's health status from the PSU exceeds (420) a predetermined health status threshold then the blood product is eliminated and the process is complete. In many embodiments, the system will automatically remove a wasted blood product from its database. However, if the blood product's health status does not exceed (420) the predetermined health status threshold, then the blood product can be checked-in and stored (406) as available for future usage.

In many embodiments, blood products that are transfused can be discarded in a designated container or waste bin. For example, in the operating room, there may be a designated location to discard the empty bags of transfused blood. The designated container or waste bin can contain one or more RFID antennas and RFID readers, arranged in a variety of manners including (but not limited to) as described for the PSU. In such a manner, when the blood product bag is discarded in the designated container or waste bin, the transfusion event is automatically documented. This information can be relayed directly to the blood product management server, or can communicate to the server via an intermediary, such as through a nearby PSU. This transfusion information can also be sent to the Electronic Medical Record for automated documentation of a blood product transfusion (time of event, volume of blood, type of blood, blood product ID, etc.). In some instances, Electronic Medical Records can also record wastage events when a wasted blood product is placed in the product waste receptacle.

Although specific processes for monitoring blood products using RFID tags are discussed above with respect to FIG. 4, any of a variety of processes for monitoring blood products utilizing RFID tags as appropriate to the requirements of a specific application can be utilized in accordance with embodiments of the invention. Processes for triggering system alerts in accordance with embodiments of the invention are further discussed below.

### Triggering System Alerts

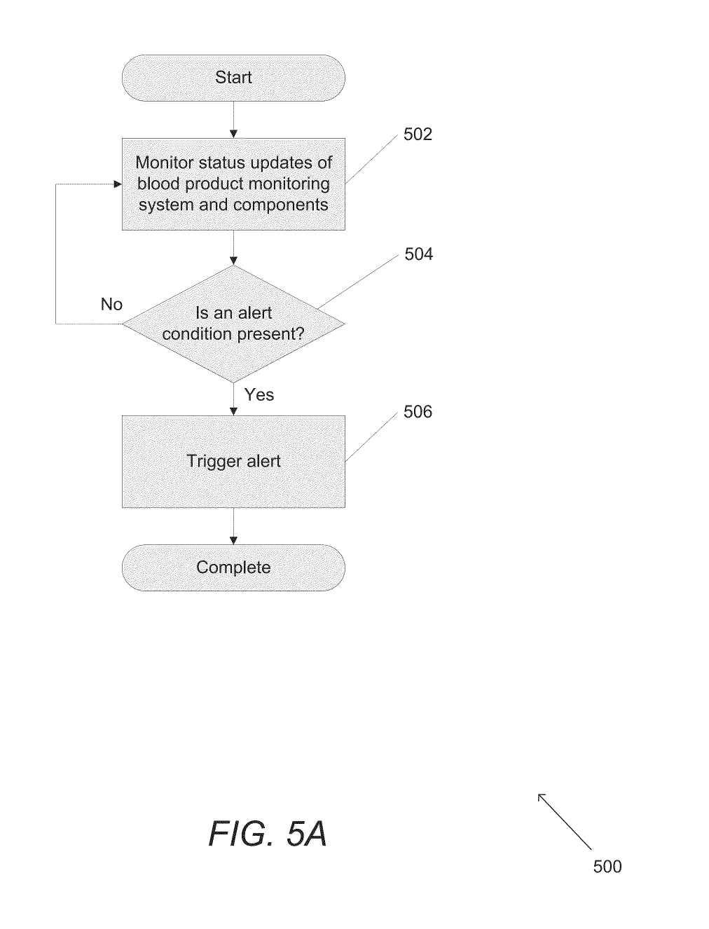

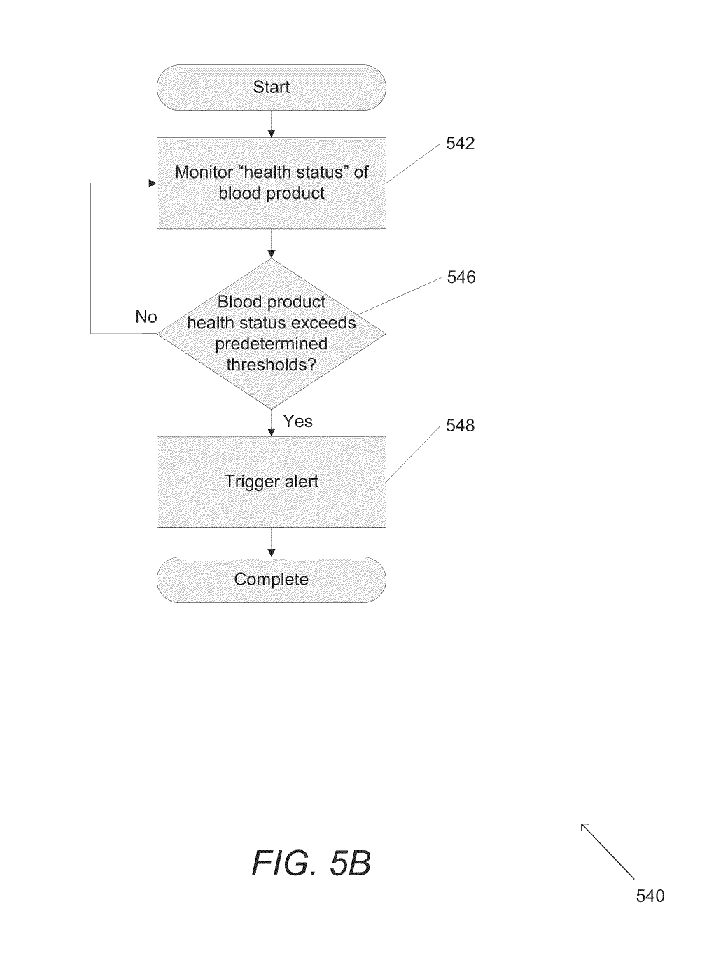

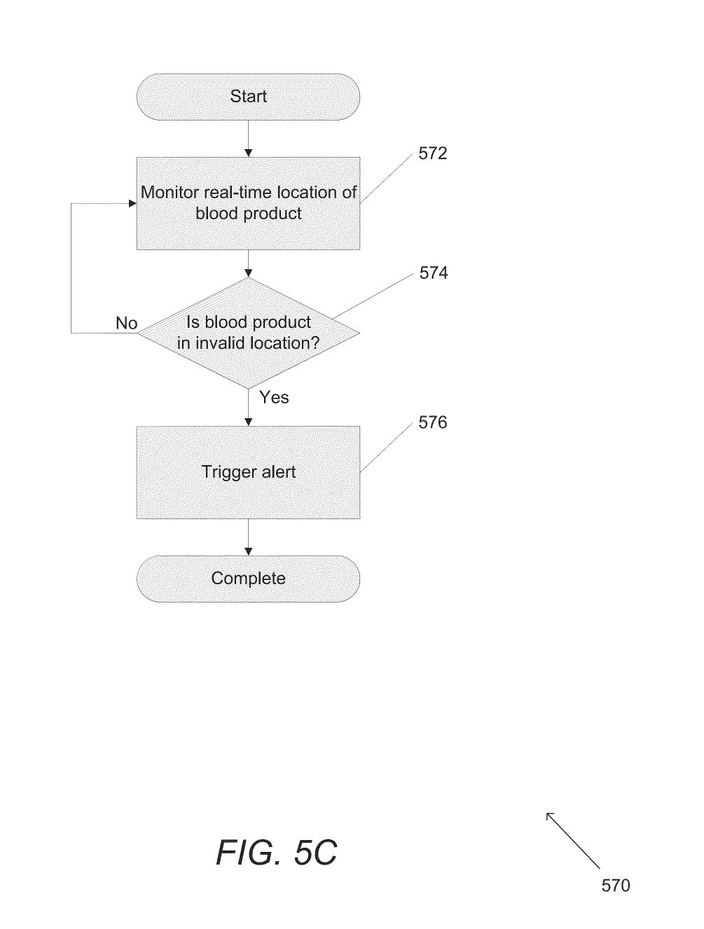

Various alerts and notifications can be provided to a user to indicate faults in the system. In many embodiments, the alerts can update a user about various blood product monitoring conditions and/or notify the user of the need to waste a blood product. A process for triggering system alerts in accordance with an embodiment of the invention is illustrated in FIGS. 5A-C. As illustrated in FIG. 5A, the process 500 includes monitoring (502) status updates of the blood product monitoring system and components as described below. If an alert condition is present (504), then an alert is triggered (506) and the process is complete. However, if an alert condition is not present (504), the process continues to monitor status updates of the blood product monitoring system and components. In many embodiments, an alert condition can include (but is not limited to) exceeding predetermined room-temperature exposure times, blood product temperatures ranges and/or PSU temperatures.

The system alerts can be triggered based on the health status of a blood product. As illustrated in FIG. 5B, the process 540 for triggering system alerts includes monitoring (542) the health status of blood products. As discussed above, the health status of a blood product can be initiated when a blood product is checked-out of the blood bank. Although the health status is discussed herein as being monitored between periods of check-in and check-out, in some implementations, the health status can be monitored continuously throughout the entire lifecycle of the blood product and even during periods of storage in the blood bank. In various embodiments, a blood product's shelf-time (time since arrival at the blood bank) can be recorded continuously for each product. In addition, the blood products' shelf-life (time until expiration date) can impact its overall health status. In several embodiments, a blood product's time on the shelf may influence its susceptibility to temperature faults. For example, an older blood product may be less tolerant of temperature violations. If the blood product's health status exceeds a predetermined threshold (546), then an alert is triggered (548) and the process is complete. However, if the blood product's health status does not exceed predetermined thresholds, then the system continues to monitor (542) the health status.

In addition, the system alerts can be triggered based on the location of a blood product. As illustrated in FIG. 5C, the process 570 includes monitoring (572) the real-time location of a blood product. In various embodiments, the location can be monitored using the RFID antenna to locate the physical location of the blood product. If the blood product is in an invalid location (574), then a system alert is triggered (576) and the process is complete. However, if the blood product is not in an invalid location (574), then the process continues to monitor (572) the real-time location of the blood product. In various embodiments, the RFID tag on a blood product can interact with an active RFID tag on a patient to warn against improper transfusion.

Although specific processes for triggering system alerts are discussed above with respect to FIGS. 5A-C, any of a variety of processes for triggering system alerts as appropriate to the requirements of a specific application can be utilized in accordance with embodiments of the invention. Processes for tracking room-temperature exposure time in accordance with embodiments of the invention are further discussed below.

### Tracking Room-Temperature Exposure Time

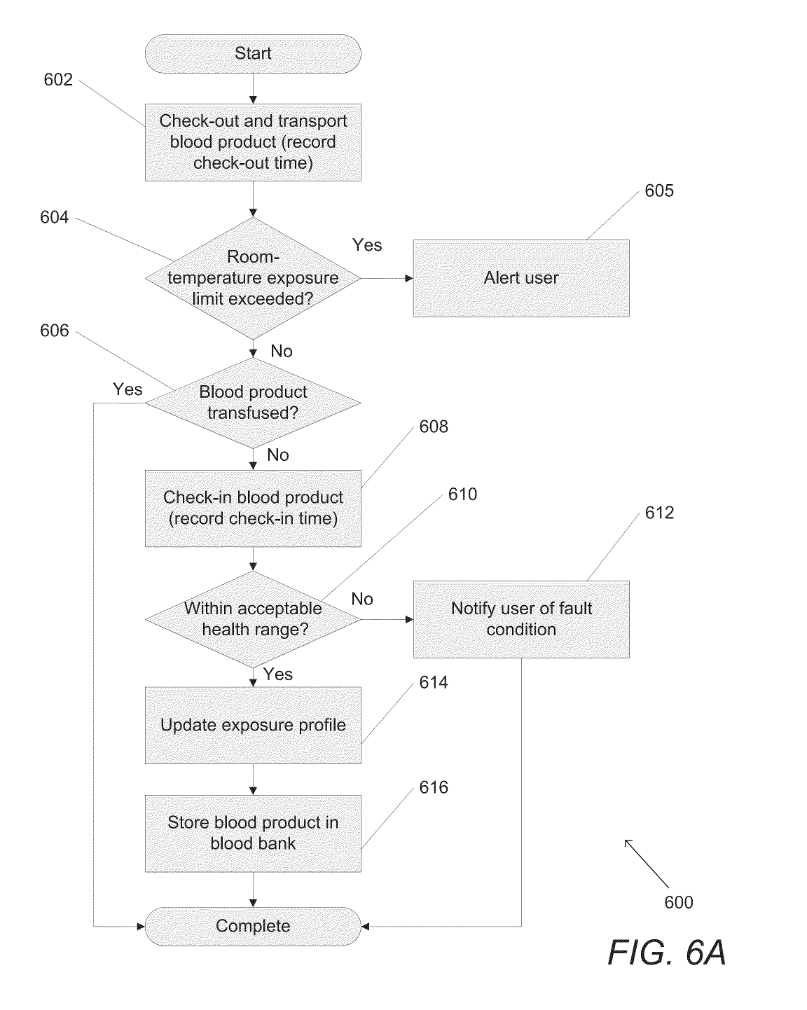

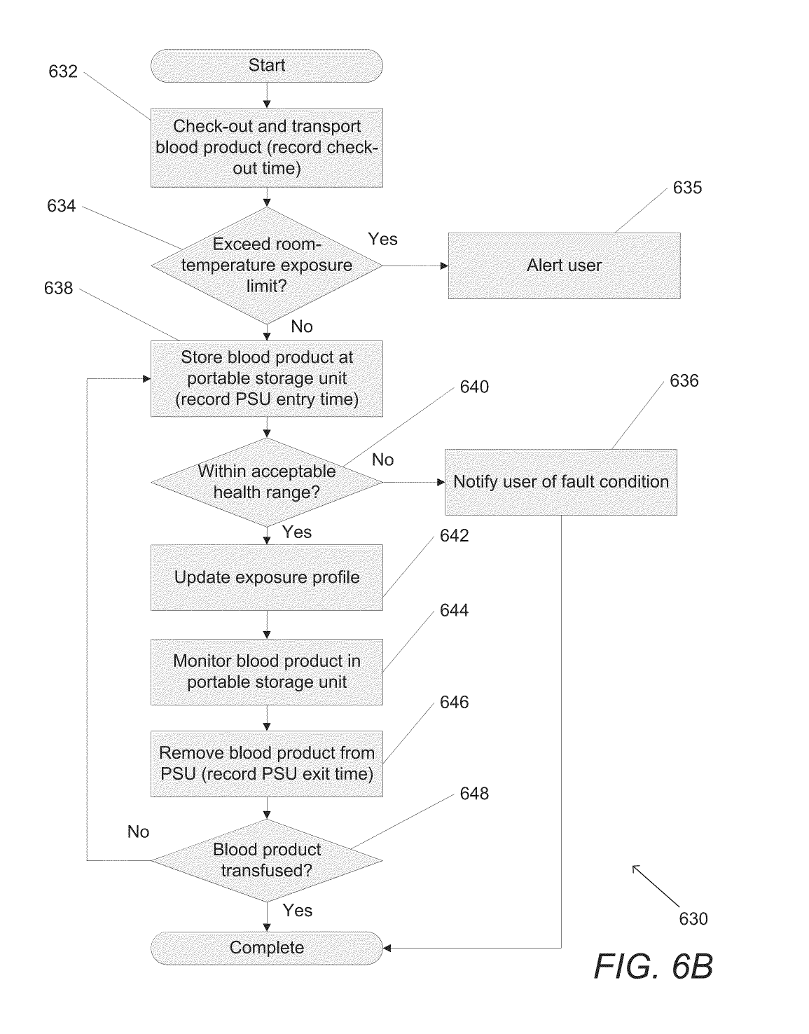

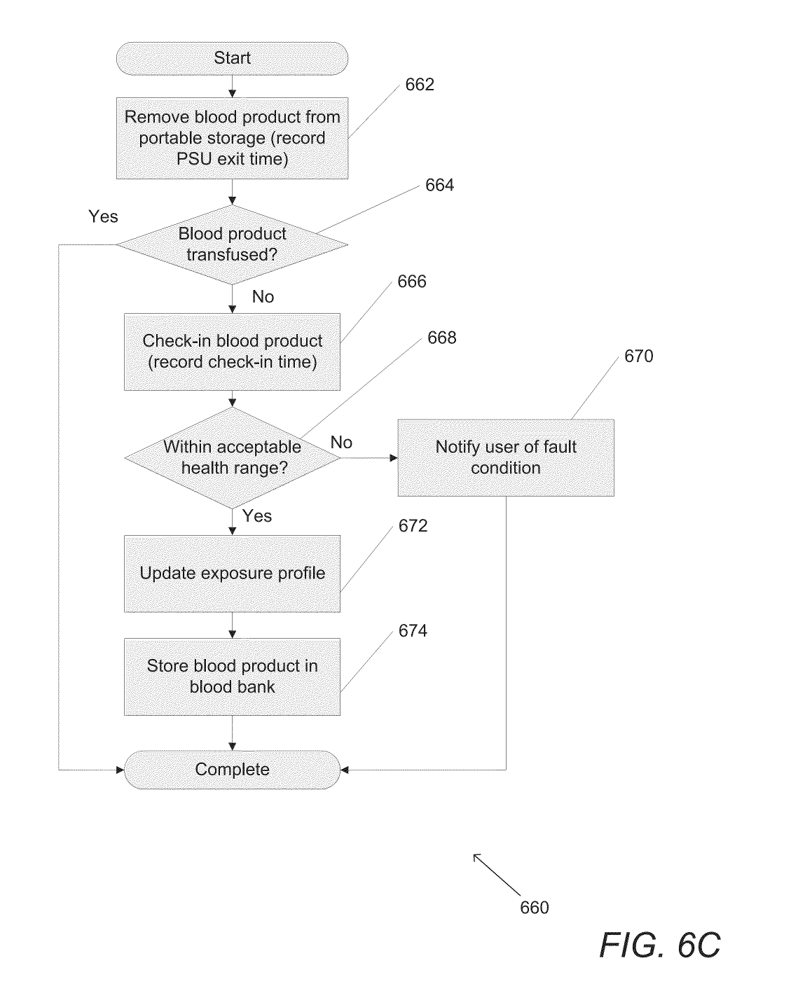

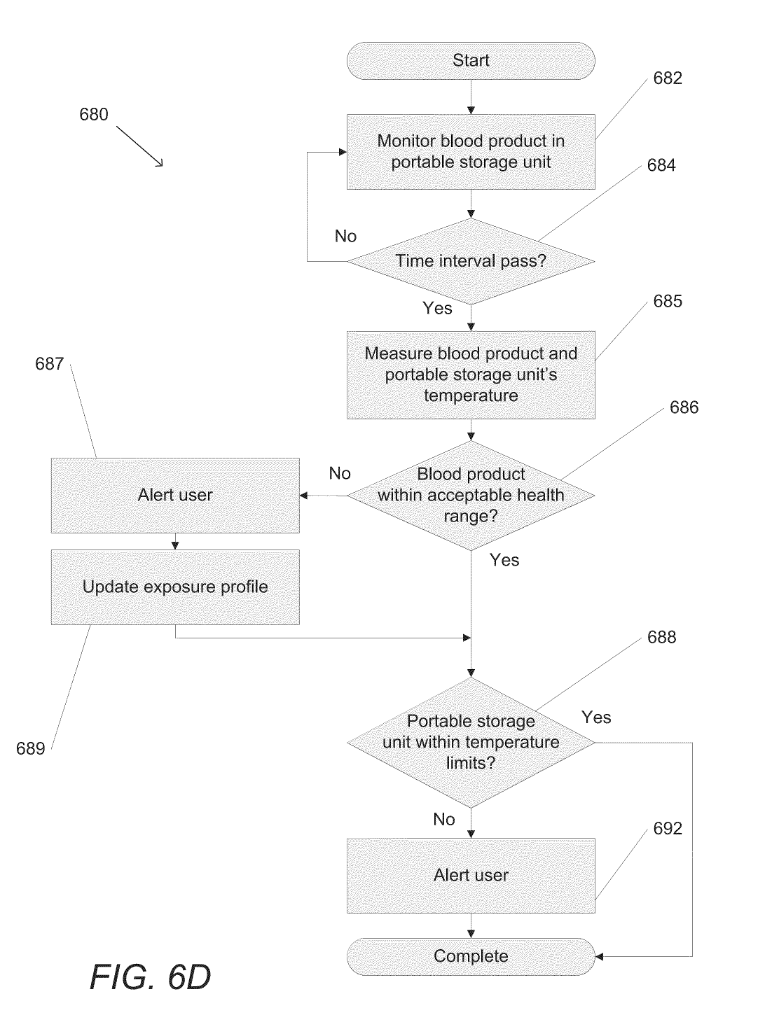

Room-temperatures exposure times, including during a single transportation to a requested location or cumulative exposures over the life of the blood product, can be a factor in determining whether a blood product should be wasted. A process for tracking room-temperature exposure time of a blood product in accordance with an embodiment of the invention is illustrated in FIGS. 6A-D.

A blood product may be checked-out from a blood bank and returned without entering by a PSU or being transfused. As illustrated in FIG. 6A, the process 600 includes checking-out (602) and transporting (602) the blood product to a requested location such as (but not limited to) an operating room. In various embodiments, time is recorded when the blood product is checked-out. Prior to transfusion, if the blood product's exposure to room-temperature exceeds (604) (or is about to exceed) a predetermined limit, then the user is alerted (605). However, if the blood product's exposure to room-temperature does not exceed (604) the limit, then the blood product is suitable for transfusion. If the blood product is utilized for transfusion (606) then the process is complete. However, if the blood product is not used for transfusion (606) then it can be returned to the blood bank and checked-in (608) where the check-in time is recorded. If the blood product's health status is not within a predetermined acceptable range (610), then the user is notified (612) of the fault condition and the process is complete. However, if the blood product's health status is within the predetermined acceptable range (610), then the blood product's exposure profile is updated (614) and the blood product is stored (616) in the blood bank for future use. In many embodiments, the blood product's health status and exposure profile are determined utilizing at least the recorded check-out time and the recorded check-in time of the blood product. In several embodiments, the difference in the two recorded times is equal to the room-temperature exposure time of a blood product. Further, the blood products health status and its exposure profiles can be stored in the blood product management server's blood product database.

A blood product may be checked-out and stored in a PSU. As illustrated in FIG. 6B, the process 630 includes checking-out and transporting (632) a blood product to a requested location. In many embodiments, the time is recorded when the blood product is checked-out. During transport, if the blood product's exposure to room-temperature exceeds (634) a predetermined limit, then the user is alerted (635). However, if the blood product's exposure to room-temperature does not exceed (634) the limit, then the blood product is stored (638) at the PSU, where the time the blood product enters the PSU is recorded. The process 630 further includes determining (640) whether the blood product's health status is within a predetermined acceptable range. If it is not (640), then the user is notified (636) of fault condition and the process is complete. However, if it is within range (640), then the blood product's exposure profile is updated (642) and the blood product is stored and monitored (644) within the PSU as further described below. In various embodiments, the updated exposure profile can be calculated using the recorded check-out time and the recorded PSU entry time and stored in the PSU's local blood product database and/or communicated to a blood product management server and stored in its blood product database. The process 630 also includes removing (646) the blood product from the PSU and recording the PSU exit time. Upon exit, if the blood product is utilized (648) for transfusion, then the process is complete. As described elsewhere herein, transfusion of a blood product can be designated by detecting the empty blood product bags in a RFID-waste container, or manually designating the transfusion, or interfacing with a separate system (such as the EMR) where blood product transfusions are documented. However, if a blood product is not utilized (648) for transfusion, then it can be stored in the PSU where the subsequent PSU re-entry time is recorded. In many embodiments, the recorded PSU exit time and re-entry time are utilized to update the blood product's room-temperature exposure to determine if the blood product's health status is still within acceptable range (640). For each time the blood product enters the PSU, the blood product's room-temperature exposure time is updated as discussed above.

A blood product may be checked-out, stored in a PSU, and returned to the blood bank for future use. As illustrated in FIG. 6C, the process 660 includes removing (662) a blood product from a PSU. In many embodiments, the PSU exit time is recorded and utilized to track the room-temperature exposure time. If the blood product is transfused (664), then the process is complete. However, if the blood product is not transfused (664), then the blood product is checked-in (666) to the blood bank and the check-in time is recorded. In various embodiments, a blood product's room-temperature exposure time is the difference between the blood product's check-out and check-in times minus the cumulative time in the PSU. In several embodiments, the blood products room temperature exposure time can be utilized to determine (668) if the blood product's health status is within a predetermined acceptable range. If it is not (668), then the user is notified (670) of the fault condition and the process is complete. However, if the blood product's health status is within the acceptable range (668), then the blood product's exposure profile is updated (672) and the blood product is stored (674) for future use and the process is complete.

In some situations, the blood product is monitored in the PSU as discussed above. A process for monitoring blood products within a PSU while tracking room-temperature exposure times in accordance with an embodiment of the invention is illustrated in FIG. 6D. The process 680 includes monitoring (682) the blood product in the PSU until a time interval has passed. If the time interval has not passed (684), then the process continues to monitor (682). However, if the time interval has passed (684), the process can include measuring (685) both the blood product's temperature and the PSU's temperature. In many embodiments, then the process includes determining (686) if the blood product's health status is within a predetermined acceptable health range and updating this status on the GUI and database. If it is not (686), then the user is alerted (687) and the blood product's exposure profile is updated (689). Second, the process determines (688) if the PSU is within predetermined temperature limits. If so (688), the process is complete and no action is taken. If the PSU is not within (688) the predetermined temperature limits, the user is alerted of such (692), and the process is complete.

Although specific processes for tracking room-temperature exposure are discussed above with respect to FIGS. 6A-D, any of a variety of processes for tracking a blood product's room-temperature exposure, as appropriate to the requirements of a specific application, can be utilized in accordance with embodiments of the invention. Processes for temperature tracking of blood products in accordance with embodiments of the invention are further discussed below.

### Tracking Blood Product Temperatures

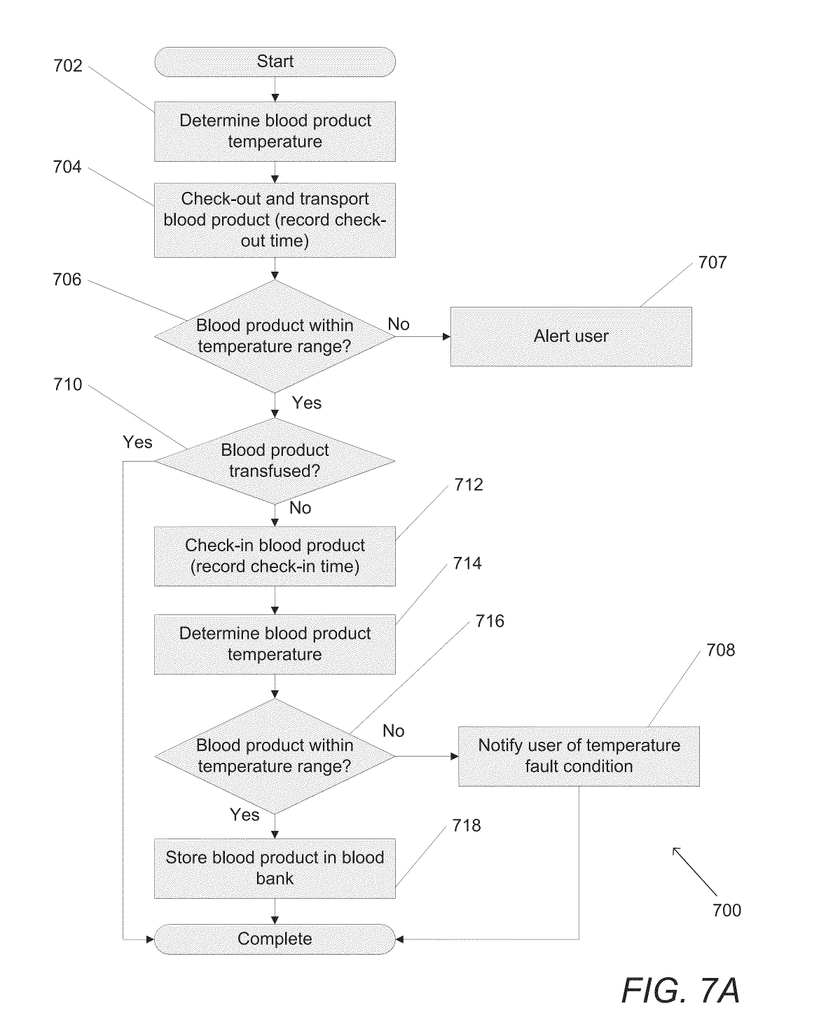

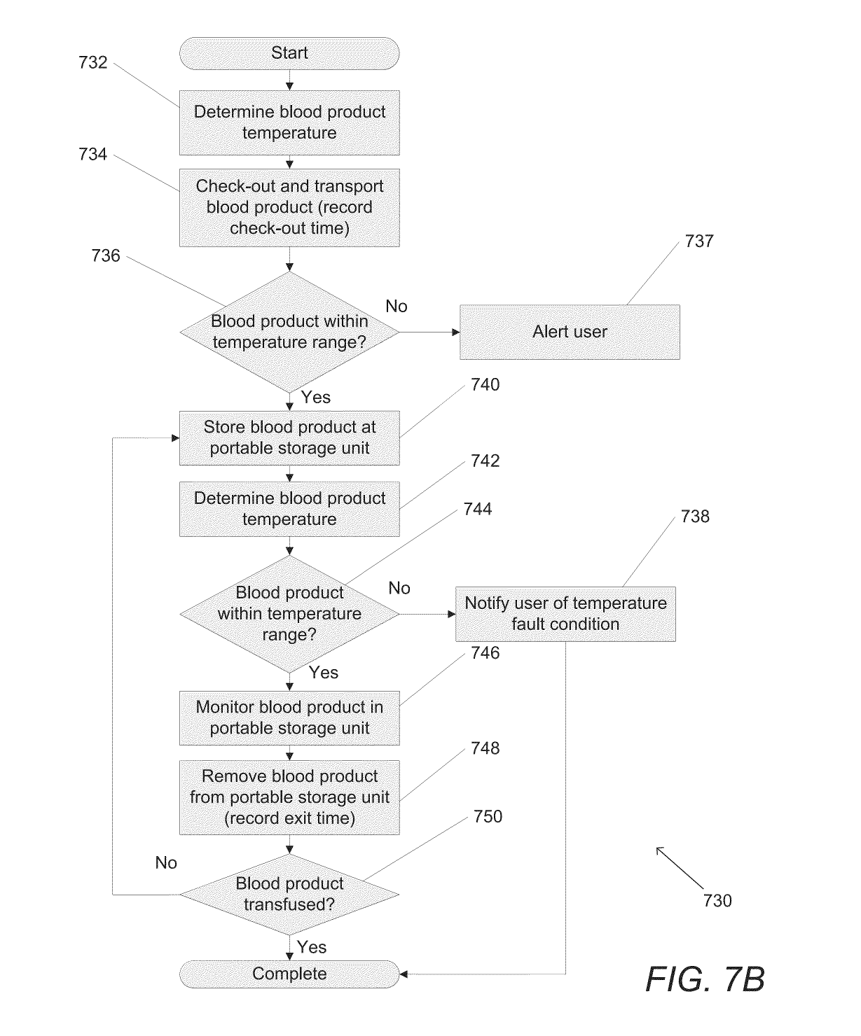

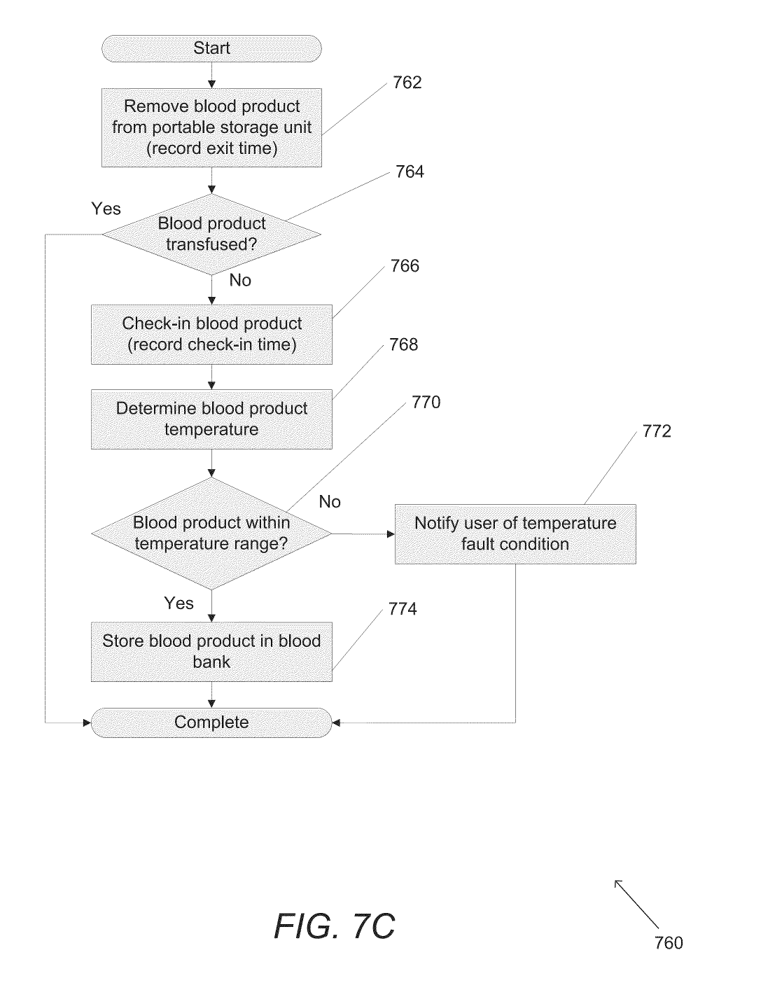

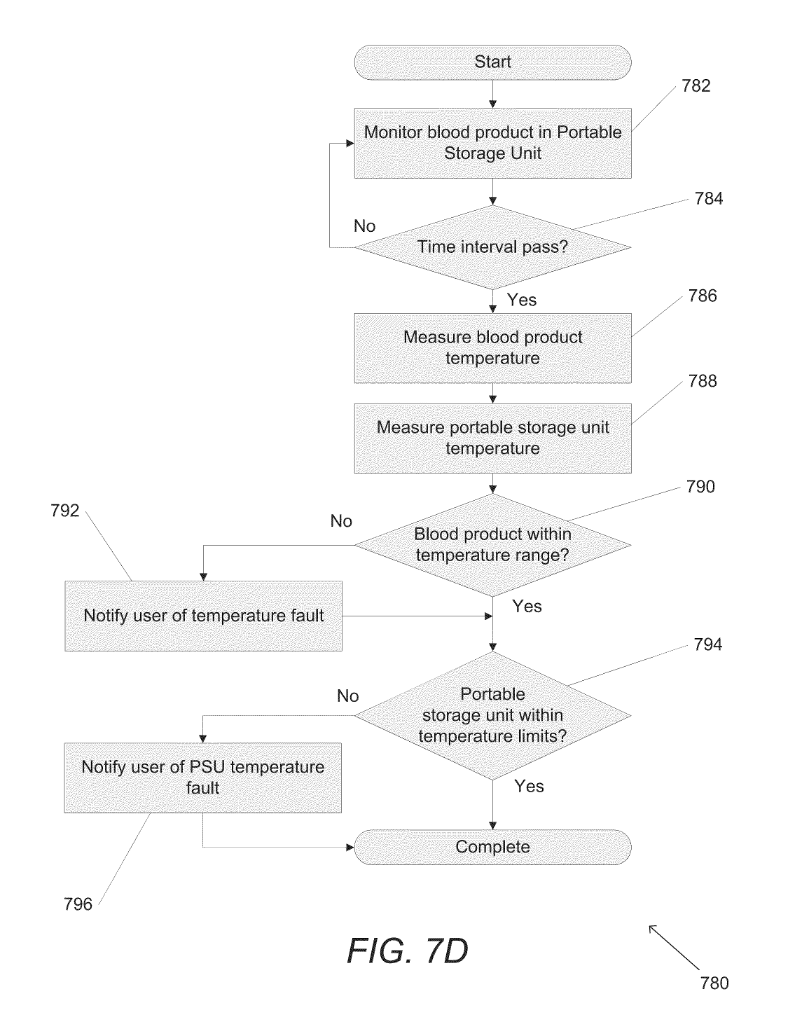

A blood product's temperature can also be a key factor in determining whether to keep or waste a blood product. A process for tracking the temperature of a blood product in accordance with an embodiment of the invention is illustrated in FIGS. 7A-D.

A blood product may be checked-out and transported to a point-of-care and returned without entering in a PSU or being utilized for transfusion. As illustrated in FIG. 7A, the process 700 includes determining (702) the temperature of the blood product. In many embodiments, the blood temperature can be directly measured or assigned in a manner well known to one of ordinary skill in the art. The process also includes checking-out (704) the blood product and transporting (704) to the requested location. In various embodiments, the check-out time is recorded. If the blood product's temperature is not within a predetermined temperature range (706), then the user can be alerted (707). However, if the blood product's temperature is within the predetermined temperature range (706), then it is made available for transfusion. If the blood product is transfused (710), then the process is complete. However, if the blood product is not utilized (710), then the blood product is returned to the blood bank and checked-in (712). In several embodiments, the check-in time is recorded. The process 700 further includes determining (714) the blood product's temperature. In many embodiments, the blood product's temperature is measured or determined as further described below. If the blood product's temperature is not within a predetermined range (716), then the user is notified (708) of the temperature fault and the process is complete. However, if the blood product's temperature is within the predetermined range (716), then the blood product is stored (718) in the blood bank and made available for future use and the process is completed.

A blood product may be checked-out and stored in a PSU. As illustrated in FIG. 7B, the process 730 includes determining (732) the temperature of the blood product. In various embodiments, the blood temperature can be directly measured or assigned in a manner well known to one of ordinary skill in the art. The process also includes checking-out (734) and transporting (734) the blood product to the requested location. In several embodiments, the check-out time is recorded. If the blood product's temperature is not within a predetermined temperature range (736), then the user can be alerted (737). However, if the blood product's temperature is within the predetermined temperature range (736), then it can be stored at the PSU (740). The process also includes determining (742) the blood product's temperature at the PSU. In many embodiments, the temperature can be measured, assigned, or determined. As described above, the PSU can include various sensors that can be utilized to determine the blood product's temperature. In various embodiments, sensor measured parameters can include (but not limited to): blood product mass, blood product temperature at check-out (i.e. before ambient exposure), time exposed to ambient temperature and the ambient temperature. The time exposure to the ambient temperature can be determined utilizing the blood product's check-out time and the PSU entry time. In calculating the blood product's temperature, constants should also be considered including (but not limited to) the blood product's specific heat, bag's surface area, bag's thickness, bag's thermal conductivity, and the ambient temperature. Thus, using the measured parameters and constants, the blood product's temperature can be determined in a manner well known to one of ordinary skill in the art.

The process 730 also includes determining (744) if the blood product's temperature is within a predetermined range. If it is not (744), then the user can be notified (738) of the temperature fault and the process is complete. However, if blood product's temperature is within the predetermined range (744), then the blood product can be monitored (746) at the PSU as further described below. At some point in time, the blood product is removed (748) from the PSU and the exit time is recorded. If the blood product is transfused (750), then the process is complete. If the blood product is not transfused (750), the blood product can be returned and stored (740) at the PSU.

In some situations, the blood product may be checked-out, stored in a PSU, and returned to the blood bank for future us. As illustrated in FIG. 7C, the process 760 includes removing (762) a blood product from a PSU. If the blood product is utilized for transfusion (764), then the process is complete. However, if the blood product is not used (764), then it is checked-in (766) where the check-in time is recorded. The process further includes determining (768) the blood product's temperature as described above. If the determined blood product's temperature is not within a predetermined range (770), then the user can be notified (772) of the temperature fault and the process is complete. If the determined blood product's temperature is within the predetermined range (770), then the blood product is stored (774) in the blood bank for future use and the process is complete.

In some situations, the blood product can be monitored in the PSU. A process for monitoring blood product's temperatures within a PSU in accordance with an embodiment of the invention is illustrated in FIG. 7D. The process 780 includes monitoring (782) the blood product in the PSU until a time interval has passed. If the time interval has not passed (784), then the process continues to monitor (782). However, if the time interval has passed (784), then the process includes measuring (786) the blood product temperature as discussed above. In many embodiments, the process can also include measuring (788) the PSU's temperature using the PSU's sensors as discussed above. If the determined blood product's temperature is within a predetermined range, then the process is complete. However, if the blood product's determined temperature is not within the predetermined range (790), then the user is notified (792) of the temperature fault. The process can also include determining (794) whether the measured PSU temperature is within temperature limits. If it is (794), then the process is complete. However, if the PSU's temperature is not within the PSU's temperature limits (794), then the user is notified (796) of the PSU's temperature fault and the process is then complete.

Although specific processes for tracking a blood product's temperature are discussed above with respect to FIGS. 7A-D, any of a variety of processes for tracking a blood product's temperature, as appropriate to the requirements of a specific application, can be utilized in accordance with embodiments of the invention.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A portable storage unit (“PSU”) configured to communicate with a blood product management server for monitoring blood products, comprising:
a cooling mechanism to control the internal temperature of the PSU;
a RFID reader configured to scan at least one RFID tag associated with at least one blood product;
a processor; and
a memory containing a PSU application;
wherein the PSU application configures the processor to:
determine a temperature profile for the at least one blood product;
generate health status information for the at least one blood product based upon the blood product's temperature profile;
generate a user interface that includes information regarding the at least one blood product's health status information; and
transmit the at least one blood product's health status information to the blood product management server.

2. The PSU of claim 1, wherein the health status information is the temperature profile.

3. The PSU of claim 1, further comprising at least one temperature sensor to measure the internal temperature of the PSU.

4. The PSU of claim 3, wherein the internal temperature of the PSU is maintained between 1 and 6 degrees Celsius.

5. The PSU of claim 3, wherein the PSU application further configures the processor to determine the temperature profile for the at least one blood product based upon the measured internal temperature of the PSU.

6. The PSU of claim 1, wherein the PSU application further configures the processor to determine the temperature profile for the at least one blood product based upon the at least one blood product's specific heat, bag characteristics, and ambient temperatures.

7. The PSU of claim 1, wherein the PSU application further configures the processor to store a PSU entry time for the at least one blood product.

8. The PSU of claim 7, wherein the PSU application further configures the processor to store a PSU exit time for the at least one blood product.

9. The PSU of claim 8, further configured to communicate with a control station comprising at least one RFID reader configured to scan blood products for check-in and check-out.

10. The PSU of claim 9, wherein the PSU application further configures the processor to determine the at least one blood product's temperature profile based upon an elapsed time between the at least one blood product's check-out time and PSU entry time.

11. The PSU of claim 9, wherein the blood product management server comprises:
a processor; and
a memory containing a blood product management server application;
wherein the blood product management server application configures the processor to:
receive the check-in and check-out times for the at least one blood product from the control station;
receive the PSU entry and exit times for the at least one blood product from the PSU; and
generate at least one alert based upon a difference in the at least one blood product's check-out and check-in times plus the difference in the PSU entry and exit times.

12. The PSU of claim 11, wherein the blood product management server application further configures the processor to generate at least one alert based upon the at least one blood product's health status information and pre-determined thresholds.

13. A method for monitoring blood products using a portable storage unit (“PSU”) configured to communicate with a blood product management server, comprising:
controlling the internal temperature of the PSU using the PSU, wherein the PSU comprises a cooling mechanism;
scanning at least one RFID tag associated with at least one blood product using the PSU, wherein the PSU comprises a RFID reader;
determining a temperature profile for the at least one blood product using the PSU;
generating health status information for the at least one blood product based upon the blood product's temperature profile using the PSU;
generating a user interface that includes information regarding the at least one blood product's health status information; and
transmitting the at least one blood product's health status information to the blood product management server using the PSU.

14. The method of claim 13, wherein the health status information is the temperature profile.

15. The method of claim 13, where the PSU further comprises at least one temperature sensor to measure the internal temperature of the PSU.

16. The method of claim 15, wherein the internal temperature of the PSU is maintained between 1 and 6 degrees Celsius.

17. The method of claim 15, further comprising determining the temperature profile for the at least one blood product using the PSU based upon the measured internal temperature of the PSU.

18. The method of claim 13, further comprising determining the temperature profile for the at least one blood product using the PSU based upon the at least one blood product's specific heat, bag characteristics, and ambient temperatures.

19. The method of claim 13, further comprising storing a PSU entry time for the at least one blood product using the PSU.

20. The method of claim 19, further comprising storing a PSU exit time for the at least one blood product using the PSU.

21. The method of claim 20 further comprising communicating with a control station comprising at least one RFID reader configured to scan blood products for check-in and check-out.

22. The method of claim 21, further comprising determining the at least one blood product's temperature profile using the PSU based upon an elapsed time between the at least one blood product's check-out time and PSU entry time.

23. The method of claim 21, further comprising:
receiving the check-in and check-out times for the at least one blood product from the control station using the blood product management server;
receiving the PSU entry and exit times for the at least one blood product from the PSU using the blood product management server; and
generating at least one alert based upon a difference in the at least one blood product's check-out and check-in times plus the difference in the PSU entry and exit times using the blood product management server.

24. The method of claim 23, further comprising generating at least one alert based upon the at least one blood product's health status information and pre-determined thresholds using the blood management server.
